(19) United States
(12) Patent Application Publication
(10) Pub. No.: US 2025/0296762 A1
(43) Pub. Date: Sep. 25, 2025

(54) Double-layer Bottle Made by In-mold Labeling Process

(71) Applicant: Technical Response, Inc., Knoxville, TN (US)

(72) Inventor: Leonard Scott Huff, Knoxville, TN (US)

(73) Assignee: Technical Response, Inc., Knoxville, TN (US)

(21) Appl. No.: 19/082,540

(22) Filed: Mar. 18, 2025

(30) Foreign Application Priority Data
Mar. 19, 2024 (CN) 202410310197.2

(51) Int. Cl. B65D 81/38; B29D 22/00; B29K 105/04; B29L 31/00; B32B 5/20

(52) U.S. Cl. CPC B65D 81/3846; B29D 22/003; B32B 5/20; B65D 81/3839; B65D 81/3841; B29K 2105/04; B29K 2995/0015; B29K 2995/0097; B29L 2031/7158; B32B 2250/02; B32B 2250/24; B32B 2307/304; B32B 2307/7376; B32B 2439/60

(57) ABSTRACT

A double-layer extruded bottle comprises an inner cup, an outer cup connected to the inner cup, an interlayer gap disposed between the inner cup and the outer cup, and a first insulation layer disposed in the interlayer gap and on an outer peripheral surface of the inner cup. The first insulation layer is integrally formed with the inner cup by an in-mold lamination process. A manufacturing method for the bottle includes forming the first insulation layer and a second insulation layer by in-mold lamination, pattern printing, punching and shaping, blow molding, and assembly and welding of the inner and outer cups. The extruded bottle has a double-layer structure that improves the heat preservation performance. The integrated molding method shortens the production cycle and reduces the production cost. Decorative patterns can be printed on outer surfaces of the insulation layers.

### FIELD

Embodiments described herein relate to the field of in-mold labeling, and in particular relate to a double-layer extruded bottle manufactured by an in-mold labeling process, and a manufacturing method thereof.

### BACKGROUND

Bottles can hold water, beverages, and other drinkable liquids. Squeeze bottles are a common type of bottle that are usually used for outdoor activities, sports and fitness, travel, and other occasions. Such bottles are usually made of soft materials such as soft plastic or silicone and have the property of being squeezable. Squeeze bottles in the prior art provide an interlayer gap between an inner cup and an outer cup of a double-layer bottle body structure to reduce heat transfer. In order to further improve the cold and heat preservation effect, squeeze bottles in the prior art also include foam in the interlayer gap to further reduce heat transfer. Not only does the foam increase the difficulty of assembly, but it also causes an unstable fit, and the cold preservation effect is not good. Also, the foam is squeezed by the outer cup after assembly, which causes wrinkles to be generated on the surface, resulting in poor appearance of the entire product.

### SUMMARY

In view of the above-mentioned deficiencies of the prior art, the purpose of the embodiments described herein is to provide a double-layer extruded bottle made by an in-mold lamination process, so as to solve the problems existing in the above-mentioned prior art.

Based on this, embodiments described herein provide a double-layer extruded bottle made by an in-mold lamination process. The bottle comprises an inner cup and an outer cup connected to the outer side of the inner cup. An interlayer gap is formed between the inner cup and the outer cup. A first insulation layer is provided on the outer peripheral surface of the inner cup and in the interlayer gap. The first insulation layer is integrally formed with the inner cup by an in-mold lamination process.

In the double-layer extruded bottle made by the in-mold lamination process as described herein, the first insulation layer is an elastomer made by a foaming or non-foaming process.

In the double-layer extruded bottle made by the in-mold lamination process as described herein, the thickness of the first insulation layer ranges from 0.1 to 3 mm.

In the double-layer extruded bottle made by the in-mold lamination process as described herein, a pattern layer is provided on the outer surface of the first insulation layer.

In the double-layer extruded bottle made by the in-mold lamination process as described herein, a second insulation layer is provided on the outer peripheral surface of the outer cup. The second insulation layer is attached to the outer peripheral surface of the outer cup by the in-mold lamination process.

In the double-layer extruded bottle made by the in-mold lamination process as described herein, a second pattern layer is provided on the outer surface of the second insulation layer.

In the double-layer extruded bottle made by the in-mold lamination process as described herein, the second insulation layer comprises thermoplastic elastomer or rubber.

In the double-layer extruded bottle made by the in-mold lamination process as described herein, the interlayer gap includes a first interlayer gap and a bottom interlayer gap. The first interlayer gap is located between the outer peripheral side of the inner cup and the outer cup, and the bottom interlayer gap is located between the bottom of the inner cup and the bottom of the outer cup. The first insulation layer is located at least in the first interlayer gap.

Embodiments described herein also provide a method for making a double-layer extruded bottle, comprising the following steps:
S1: forming a first insulation layer for attachment inside the inner cup mold and a second insulation layer for attachment inside the outer cup mold;
S2: printing text and/or patterns on the outer surfaces of the first insulation layer and the second insulation layer;
S3: punching the first insulation layer and the second insulation layer into shape;
S4: placing the first insulation layer into the inner cup molding cavity of an extrusion blow mold, forming the first insulation layer and the inner cup as one piece by blow molding, placing the second insulation layer into the extrusion blow mold, and forming second insulation layer onto the outer cup; and
S5: assembling and welding the inner cup and the outer cup into one piece.

Embodiments described herein also provide a method for making a double-layer extruded bottle as described herein, wherein the first insulation layer and the second insulation layer are made by extrusion molding, compression molding, or injection molding.

The implementation of the embodiments described herein has the following beneficial effects:

1. The squeeze bottle adopts a double-layer structure that improves the thermal insulation performance. An interlayer gap is formed between the inner cup and the outer cup, which can effectively slow down the heat transfer, maintain the temperature of the liquid, and play an insulating and heat-insulating effect, thereby improving the thermal insulation performance. Embodiments described herein adopt an in-mold lamination process to form the thermal insulation layer and the inner cup in one piece, and to finely laminate the inner cup and the outer cup of the double-layer cup. This improves the adhesion and durability of the thermal insulation material on the bottle, thereby improving the thermal insulation performance. Further, the one-piece molding method can shorten the production cycle and reduce the production cost.

2. The material of the first thermal insulation layer is an elastomer. The characteristics of the elastomer, combined with the squeeze bottle described herein, provide consumers a better experience. The material is made using a foaming or non-foaming process. If a foaming process is used, bubbles or foam structures can be formed in the processed film, thereby greatly enhancing the insulation and heat preservation effects, while also providing a decorative effect. If a non-foaming process is used, a dense material will be produced, which is more suitable for materials that require higher strength and durability, and which can allow the first insulation layer to play a decorative and insulating role.

3. The material of the second insulation layer on the outer cup comprises thermoplastic elastomer or rubber, and the second insulation layer has a second pattern layer, which can play a decorative and additional insulating role.

4. The manufacturing method of the double-layer squeezed bottle described herein finely applies film to the inner cup and the outer cup of the double-layer cup, and improves the adhesion and durability of the insulation material on the bottle, thereby improving the insulation performance. According to the manufacturing method of the double-layer squeezed bottle described herein, the first insulation layer and the inner cup, and the second insulation layer and the outer cup are all integrally formed, thereby shortening the production cycle, and reducing the production cost. The pattern is printed on the outer surface of the first insulation layer of the inner cup without wrinkles, and the pattern is printed on the outer surface of the second insulation layer of the outer cup, which can play a better decorative role.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views. The drawings described below are directed to only some embodiments of the present application. For ordinary technicians in this field, other drawings can be obtained based on these drawings without creative work.

FIG. 1 is an overall schematic diagram of an embodiment of the present disclosure.

FIG. 2 is an exploded schematic diagram of an embodiment of the present disclosure.

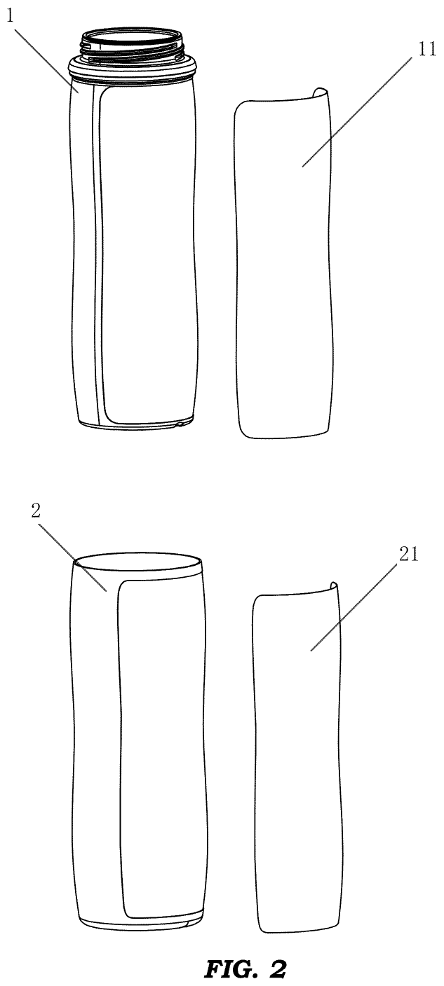

FIG. 3 is a cross-sectional schematic diagram of an embodiment of the present disclosure.

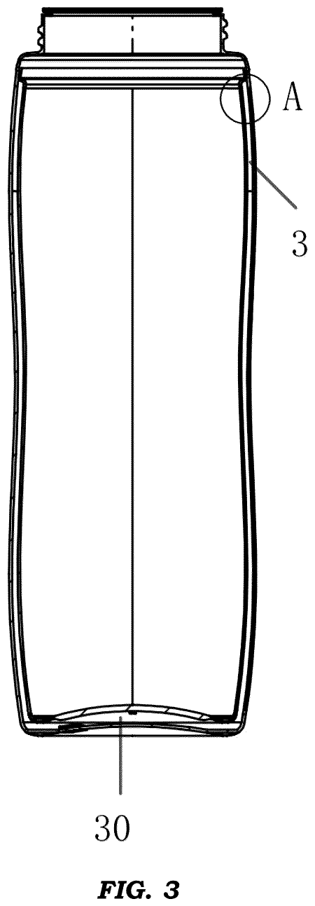

FIG. 4 is an enlarged view of portion A in FIG. 3.

### DETAILED DESCRIPTION

The following description when considered with reference to the drawings provides a clear and complete description of the technical solutions in the embodiments of the present invention. It should be apparent that the described embodiments are only part of the embodiments of the present invention, not all of the embodiments. Based on the embodiments described herein, all other embodiments obtained by ordinary technicians in this field without creative work are within the scope of protection of the present invention.

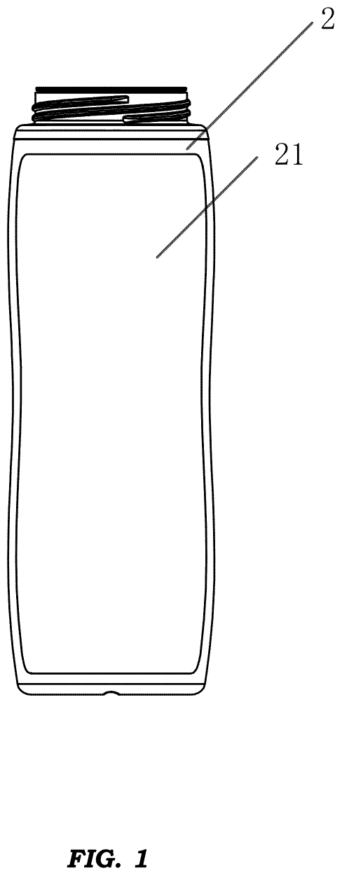

As shown in FIG. 1, an embodiment of the present invention provides a double-layer squeeze bottle made by an in-mold lamination process. The bottle comprises an inner cup 1 and an outer cup 2 connected to the outer side of the inner cup 1. An interlayer gap 3 is formed between the inner cup 1 and the outer cup 2. A first insulation layer 11 is provided on the outer peripheral surface of the inner cup 1 and is located in the interlayer gap 3. The first insulation layer 11 is integrally formed with the inner cup 1 by an in-mold lamination process. In a preferred embodiment, the inner cup 1 and the outer cup 2 are made of polypropylene (PP) plastic, which is easy to extrude and has good durability. However, the inner cup 1 and the outer cup 2 could also be made of other materials, not limited to PP plastic.

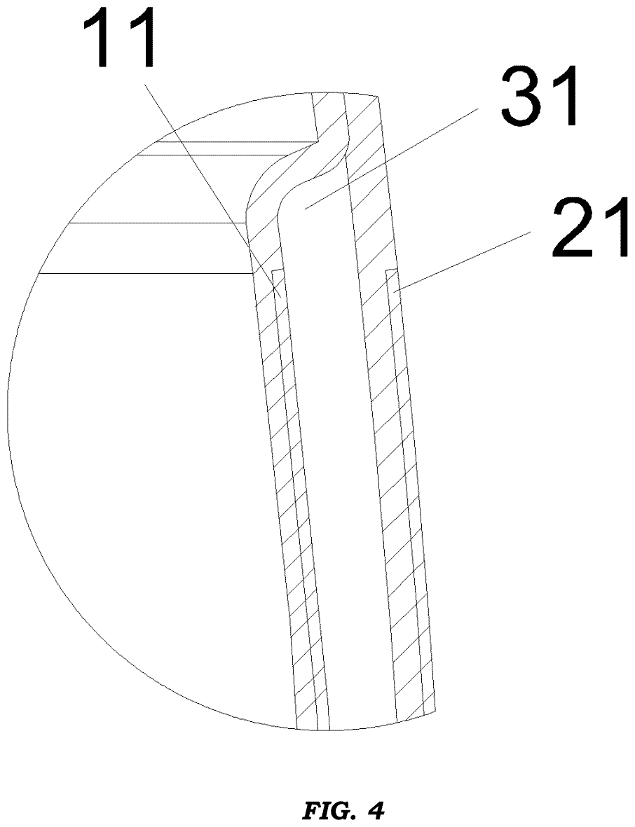

As shown in FIG. 4, the interlayer gap 3 formed between the inner cup 1 and the outer cup 2 can effectively slow down the heat transfer, maintain the temperature of the liquid in the inner cup 1, and provide an insulating and heat-preserving effect to improve the thermal insulation performance. Preferably, the thickness of the interlayer gap 3 is in the range of 0.5 mm-3.0 mm. In some embodiments, the interlayer gap 3 may be filled with air, and a certain space is left between the inner cup and the outer cup, which can play a role in heat preservation and heat insulation. Air as an insulator can slow down heat conduction and help maintain the temperature of the liquid. In some embodiments, the interlayer gap 3 may be filled with a vacuum, which can provide better thermal insulation effect. A vacuum is the best insulator and has almost no heat conduction. Alternatively, the interlayer gap may be filled with foaming materials, such as expanded polystyrene (EPS) foam, polyurethane foam, etc. These materials have low thermal conductivity, can provide additional thermal insulation effect, and are lightweight and easy to process. The use of an in-mold lamination process to integrally form the thermal insulation layer 11 and the inner cup 1 can ensure the close combination and stability of the thermal insulation layer and the inner cup, thereby improving the thermal insulation performance of the embodiments described herein. Specifically, the in-mold lamination process should take into account the structure of the inner cup 1, the outer cup 2, and the interlayer gap 3 to ensure that the thermal insulation layer 11 can be accurately fitted on the outer peripheral surface of the inner cup 1 during the manufacturing process. The in-mold lamination process should set to an appropriate position to ensure that the thermal insulation layer 11 can be accurately fitted on the outer peripheral surface of the inner cup 1. In some embodiments, the thermal insulation layer 11 is integrally formed with the inner cup 1 through blow molding or other manufacturing processes to ensure the uniformity and stability of the thermal insulation layer 11. In some embodiments, grooves or protrusions may be added to the mold design used in the in-mold labeling process to improve the adhesion and stability between the insulation layer 11 and the inner cup 1. The design of the outer cup 2 can be decorated as required, and can also play an additional role in heat preservation. The double-layer squeezed bottle made by the in-mold labeling process can take into account the characteristics of beauty, heat preservation, and durability, thereby providing users with a better use experience.

Embodiments of the squeeze bottle described herein adopt a double-layer structure, which improves the thermal insulation performance. An interlayer gap is formed between the inner cup and the outer cup, which can effectively slow down the heat transfer, maintain the temperature of the liquid, provide an insulating effect, and improve the thermal insulation performance. Some embodiments described herein adopt an in-mold lamination process to form the thermal insulation layer and the inner cup in one piece. The preferred process finely laminates the inner cup and the outer cup of the double-layer cup, which improves the adhesion and durability of the thermal insulation material on the bottle, thereby improving its thermal insulation performance. The one-piece molding method can also shorten the production cycle and reduce production costs.

In preferred embodiments, the thermal insulation layer 11 is an elastomer made by a foaming or non-foaming process. The elastomer may be selected from materials such as thermoplastic elastomer (TPE), ethylene-vinyl acetate (EVA), polyurethane (PU), rubber, etc. The elastomer material preferably has a low thermal conductivity and a certain insulation performance, so it can effectively slow down the transmission of heat, thereby providing a certain degree of thermal insulation effect. The specific insulation effect depends on factors such as the type, density, thickness, and environmental conditions of the elastomer. In preferred embodiments of the double-layer squeeze bottle, the elastomer provides a thermal insulation layer, which prevents heat from being transferred from the inner cup to the outer cup to a certain extent, thereby slowing down the change rate of the liquid temperature. In this way, the temperature of the liquid can be maintained for a longer period of time, thereby providing a better thermal insulation effect. Preferably, the elastic body insulation layer is made by a foaming process, and the bubble structure inside the elastic body insulation layer can play a decorative and insulating role. In some embodiments, the foaming process foams the selected material, and a physical or chemical foaming method can be used to form bubbles or foam structures inside the material. The foamed material is then molded to form an insulation layer that conforms to the shape of the outer peripheral surface of the inner cup. Then, the insulation layer and the inner cup are integrally molded by an in-mold labeling process to ensure that the insulation layer and the inner cup are firmly bonded. Preferably, non-foamed elastomeric materials, such as silicone, rubber, etc., are also formed in the same process as the foaming process to form an insulation layer that conforms to the shape of the outer surface of the inner cup. The insulation layer and the inner cup are integrally formed using an in-mold labeling process to ensure that they are firmly fixed and free of bubbles.

In some embodiments, the thickness of the insulation layer 11 is in the range of 0.1 mm-3 mm. Specifically, the appropriate thickness can be selected according to different product specifications and usage scenarios. A thinner insulation layer having a thickness of about 0.1 mm makes the entire bottle lighter and more suitable for carrying and use than a thicker insulation layer. A thinner insulation layer is also softer and more flexible, and can better adapt to bottle inner cups of different shapes and sizes, making the manufacturing process more flexible and saving material costs. A thicker insulation layer having a thickness of about 3 mm generally provides a better insulation effect. Due to its greater thickness, it can provide more thermal and sound insulation materials, effectively slowing down heat conduction, thereby keeping the temperature of the liquid in the inner cup longer. The thicker insulation layer also has better durability and can better protect the inner cup from external impact and damage. This is especially important for bottles used outdoors or in sports, which can increase the service life of the product.

Furthermore, the outer surface of the thermal insulation layer 11 is provided with a pattern layer. Specifically, a printing technology is used to print the designed pattern on the thermal insulation layer 11. Digital printing, screen printing, thermal transfer and other technologies can be used to ensure that the pattern is clear and colorful. The pattern layer can play a decorative role, so that consumers have a better experience.

In some embodiments, a second insulation layer 21 is provided on the outer surface of the outer cup 2. The second insulation layer 21 is preferably attached to the outer surface of the outer cup 2 by an in-mold labeling process. As shown in FIG. 1, the second insulation layer 21 has a rounded rectangular shape. The second insulation layer 21 is preferably attached to the outer surface of the outer cup 2, thereby ensuring that the material selected for the second insulation layer 21 is suitable for the in-mold labeling process. The second insulation layer 21 may be firmly combined with the surface of the outer cup to play the role of insulation and heat preservation.

In some embodiments, a second pattern layer is provided on the outer surface of the second thermal insulation layer 21. Specifically, a printing technology may be used to print the designed pattern on the second thermal insulation layer 21. Digital printing, screen printing, thermal transfer and other technologies can be used to ensure that the pattern is clear and colorful. The second pattern layer can play a decorative role, so that consumers have a better experience.

In some embodiments, the second insulation layer 21 comprises thermoplastic elastomer or rubber.

In some embodiments, the second insulation layer 21 is preferably made of a thermoplastic elastomer, and is made to conform to the shape of the outer peripheral surface of the outer cup through a thermoplastic elastomer molding process. During the production process, the second insulation layer made of thermoplastic elastomer is integrally molded with the outer cup through an in-mold labeling process to ensure that it is firmly fixed and the shape meets the requirements, which can play an additional role in insulation and heat preservation.

In some embodiments, the interlayer gap 3 includes a first interlayer gap 31 between the outer circumference of the inner cup and the outer cup, and a bottom interlayer gap 30 between the bottom of the inner cup and the bottom of the outer cup. In such embodiments, the thermal insulation layer 11 is located at least in the first interlayer gap 31. As shown in FIG. 4, the first interlayer gap 31 is located between the outer circumference of the inner cup and the outer cup. Suitable interlayer materials are usually materials with good insulation properties, such as foam plastics, air, vacuum, etc. Preferably, the thickness of the first interlayer gap 31 is in the range of 0.5-3 mm, and the thickness of the bottom interlayer gap 30 is in the range of 0.5-3 mm. The interlayer material may be made into a desired shape and size by injection molding, pressing, and other processes. It should be noted that the use of in-mold labeling technology can ensure that the insulation layer is firmly bonded to the inner surface of the first interlayer gap, keeping it fixed and stable. Preferably, a special mold can be designed to ensure that the first interlayer gap and the bottom interlayer gap can be accurately combined with the inner cup and the outer cup, and the insulation layer can be fixed in the first interlayer gap. The insulation layer 11 is located at least in the first interlayer gap 31. That is, the insulation layer 11 is not limited to the first interlayer gap 31. It could be between other interlayer gaps, such as the bottom interlayer gap 30. However, it should at least be in the first interlayer gap, which can provide more insulation effects and prevent heat conduction from different positions.

Embodiments described herein also provide a method for making a double-layer extrusion bottle, including the following steps:
S1: forming a first insulation layer 11 for in-mold attachment of the inner cup 1 and a second insulation layer 21 for in-mold attachment of the outer cup 2;
S2: printing text and/or patterns on the outer surfaces of the first insulation layer 11 and the second insulation layer 21;
S3: punching the first insulation layer 11 and the second insulation layer 21 into shape;
S4: placing the first insulation layer 11 into the molding cavity of the inner cup 1 of the extrusion blow mold, forming the first insulation layer 11 and the inner cup 1 as one piece by blow molding, placing the second insulation layer 21 into the extrusion blow mold, and forming it onto the outer cup 2; and
S5: assembling and welding the inner cup 1 and the outer cup 2 into one piece.

In step S1, suitable materials and molding processes are used to manufacture the first insulation layer 11 attached in the inner cup mold and the second insulation layer 21 attached in the outer cup mold. The insulation layer 11 is preferably an elastomer selected from materials such as TPE, EVA, PU, rubber, etc. The elastomer material has a low thermal conductivity and certain insulation properties, so it can effectively slow down the transfer of heat, thereby providing a certain degree of insulation effect. In step S2, the text and/or pattern are designed according to the requirements, and a suitable printing method is selected, such as silk screen printing, thermal transfer, UV printing, etc. In step S3, the first insulation layer 11 and the second insulation layer 21 are cut according to the predetermined shape using a punching device to meet the size requirements of the inner cup and the outer cup. In step S4, the punched first insulation layer is placed in the inner cup molding cavity of the extrusion blow mold, and the first insulation layer and the inner cup are integrally formed by blow molding. The second insulation layer is placed in the extrusion blow mold and molded onto the outer cup. Preferably, the second insulation layer and the outer cup are integrally formed to ensure that the second insulation layer fits tightly to the surface of the outer cup. In step S5, the inner cup and the outer cup are assembled together according to the design requirements to ensure the alignment and fit of the inner and outer cups. In preferred embodiments, the inner and outer cups are welded together to ensure that the product structure is stable and sealed.

Through the above steps, the production process of the double-layer squeezed bottle can be completed, including the molding of the insulation layer and the second insulation layer, pattern printing, punching and shaping, blow molding, and assembly and welding of the inner and outer cups. By adding the first insulation layer and the second insulation layer between the inner cup and the outer cup, the insulation performance of the double-layer squeezed bottle can be effectively improved. The insulation layers can prevent the conduction of heat and keep the temperature of the liquid stable for a longer time. Printing text and/or patterns on the outer surface of the first insulation layer and the second insulation layer can achieve personalized customization, meet the needs and preferences of different consumers, and enhance the market appeal of the product. The use of separate molding, pattern printing, punching and shaping, and blow molding process steps can make the production process more efficient and standardized, thereby improving production efficiency and reducing production costs.

The manufacturing method of the double-layer squeeze bottle can finely apply film to the cup body of the inner cup and the outer cup of the double-layer cup, and improve the adhesion and durability of the thermal insulation material on the bottle, thereby improving the thermal insulation performance. In preferred embodiments, the first thermal insulation layer and the inner cup, and the second thermal insulation layer and the outer cup are all integrally formed. This shortens the production cycle and reduces the production cost. The pattern is preferably printed on the outer surface of the first thermal insulation layer of the inner cup, and the pattern is printed on the outer surface of the second thermal insulation layer of the outer cup, without generating wrinkles, and can play a better decorative role.

In some embodiments, the first insulation layer 11 and the second insulation layer 21 are made by extrusion molding, compression molding or injection molding. Such molding methods are implemented so that the first insulation layer and the inner cup, and the second insulation layer and the outer cup can be integrally formed, thereby shortening the production cycle and reducing the production cost.

It should be understood that the description herein uses the terms “first”, “second”, etc. to describe various information, but such information should not be limited to these terms, and these terms are only used to distinguish the same type of information from each other. For example, without departing from the scope of the present invention, the “first” information may also be referred to as the “second” information, and similarly, the “second” information may also be referred to as the “first” information. In addition, the terms “center”, “up”, “down”, “left”, “right”, “vertical”, “horizontal”, “inside”, “outside” and “center” are based on orientation or positional relationship shown in the drawings, and are used only for the convenience of describing the embodiments and simplifying the description. Use of such terms does not indicate or imply that the device or element referred to must have a specific orientation, or be constructed and operated in a specific orientation, and therefore should not be understood as a limitation on the present invention.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A double-layer bottle made by an in-mold lamination process, the double-layer bottle comprising:
an inner cup;
an outer cup connected to an outer surface of the inner cup;
an interlayer gap disposed between the inner cup and the outer cup; and
a first insulation layer disposed in the interlayer gap and on an outer peripheral surface of the inner cup,
wherein the first insulation layer is integrally formed with the inner cup by the in-mold lamination process.

2. The double-layer bottle of claim 1, wherein the first insulation layer comprises an elastomer made by a foaming or non-foaming process.

3. The double-layer bottle of claim 1, wherein a thickness of the first insulation layer ranges from 0.1 mm to 3 mm.

4. The double-layer bottle of claim 1, further comprising a first pattern layer disposed on an outer surface of the first insulation layer.

5. The double-layer bottle of claim 4, further comprising a second insulation layer disposed on an outer peripheral surface of the outer cup, wherein the second insulation layer is attached to the outer peripheral surface of the outer cup by in-mold lamination.

6. The double-layer bottle of claim 5, further comprising a second pattern layer disposed on an outer surface of the second insulation layer.

7. The double-layer bottle of claim 5, wherein the second insulation layer comprises thermoplastic elastomer, ethylene-vinyl acetate, polyurethane, or rubber.

8. The double-layer bottle of claim 1, wherein the interlayer gap comprises a first interlayer gap located between the inner cup and the outer cup, and a bottom interlayer gap disposed between a bottom of the inner cup and a bottom of the outer cup, and wherein the first insulation layer is disposed in at least the first interlayer gap.

9. A method for manufacturing the double-layer bottle of claim 5, the method comprising the following steps:
forming the first insulation layer for in-mold attachment to the inner cup and the second insulation layer for in-mold attachment to the outer cup;
printing one or more of text and patterns on outer surfaces of the first insulation layer and the second insulation layer;
punching the first insulation layer and the second insulation layer into shape;
placing the first insulation layer into a molding cavity of an extrusion blow mold and forming the first insulation layer and the inner cup as a whole by blow molding;
placing the second insulation layer into the extrusion blow mold, and forming the second insulation layer onto the outer cup; and
assembling and welding the inner cup and the outer cup together.

10. A method for manufacturing the double-layer bottle according to claim 9, wherein the first insulation layer and the second insulation layer are formed by extruding sheets and punching, or by compression molding, or by injection molding.

11. The double-layer bottle of claim 4, wherein the first pattern layer is applied by a 3D texture process, a digital printing process, a screen printing process, or a thermal transfer process.

12. The double-layer bottle of claim 6, wherein the second pattern layer is applied by a 3D texture process, a digital printing process, a screen printing process, or a thermal transfer process.
